(19) United States
(12) Patent Application Publication
(10) Pub. No.: US 2025/0377000 A1
(43) Pub. Date: Dec. 11, 2025

(54) Flow Conditioning Insert

(71) Applicant: Badger Meter, Inc., Milwaukee, WI (US)

(72) Inventors: Kirk Henderson, Oconomowoc, WI (US); Jon-David Schuetze, Milwaukee, WI (US); Issa Dandan, Pleasant Prairie, WI (US); Daniel Brennan, Whitefish Bay, WI (US); Jeremy Aderhold, Cedarburg, WI (US)

(21) Appl. No.: 18/739,624

(22) Filed: Jun. 11, 2024

(51) Int. Cl. F15D 1/02; G01F 1/66

(52) U.S. Cl. CPC F15D 1/025; G01F 1/662

(57) ABSTRACT

A flow conditioning insert for insertion in a flow conduit transporting a flow stream is described. The flow conditioning insert includes an inlet side receiving the flow stream, an outlet side receiving the flow stream after the flow stream passes through the inlet side, and an internal structure positioned between the inlet side and the outlet side and positioning the flow conditioning device within the flow conduit. The internal structure includes a plurality of a flow conditioning apertures extending between the inlet side and the outlet side and a plurality of flow mixing diverters positioned within one or more flow conditioning apertures, each flow mixing diverter imparting a directional flow condition on fluid passing through a flow conditioning aperture that includes the flow mixing diverter.

### FIELD OF THE INVENTION

This application relates to a flow conditioner used to increase the consistency of a flow profile inside a measurement zone to improve the accuracy of any meter performing the measurement.

### BACKGROUND

Flow conditioning inserts are typically used to manage swirl and increase the consistency of a flow profile inside a pipe to improve the accuracy of any meter that determines an average velocity within a measurement zone. When an asymmetrical flow moves through the measurement zone it can result in ultrasonic signal path measurements not properly representing the total volume of the water massing through the meter. The flow conditioning reduces the degree of variation within the cross section of the measurement zone. Flow conditioners are used typically in round pipes with a variety of flow meters such as a residential water meter, a mechanical flow meter, an ultrasonic meter, etc.

However, typical flow conditioners have suboptimal performance under certain conditions. For example, one such condition occurs when a flow is directed around a pipe elbow. The elbow introduces swirl into the flow that reduces the consistency of the flow and creates an asymmetrical flow across a cross-section of the pipe for a length of the pipe. An elbow further increases the velocity of the flow at the outside of the elbow while simultaneously decreasing the velocity at the inside of the elbow. Flow conditioning inserts typically require a length of straight pipe to have a uniform flow prior to flow being conditioned by a flow conditioner. Flow conditioning inserts are specifically designed to reduce the impact of asymmetrical incoming flow profiles on residential flow meters.

Accordingly, there remains a need for a flow conditioning insert that is configured to condition a flow having an asymmetric flow profile. There further remains a need for such a flow conditioning insert conditioning the flow by distributing the asymmetry to create an consistency that is uniform across the diameter of the flow profile.

### SUMMARY

This application relates to a flow conditioner used to increase the consistency of a flow profile inside a measurement zone to improve the accuracy of any meter by using one or more flow mixing diverters.

The present application is directed to a flow conditioning insert for insertion in a flow conduit transporting a flow stream. The flow conditioning insert includes an inlet side receiving the flow stream, an outlet side receiving the flow stream after the flow stream passes through the inlet side, and an internal structure positioned between the inlet side and the outlet side and positioning the flow conditioning device within the flow conduit. The internal structure includes a plurality of a flow conditioning apertures extending between the inlet side and the outlet side and a plurality of flow mixing diverters positioned within one or more flow conditioning apertures, each flow mixing diverter imparting a directional flow condition on fluid passing through a flow conditioning aperture that includes the flow mixing diverter.

In one exemplary embodiment, the flow conditioning apertures are divided into subgroups and the flow mixing diverters within each subgroup are configured to cooperatively impart the directional flow condition. The directional flow condition may be a helical swirl. In another embodiment, the subgroups form quadrants of flow conditioning apertures.

In another exemplary embodiment, the flow conditioning insert includes one or more flow outlet vanes isolating a flow output from each subgroup beyond the length of the internal structure of the flow insert. In another embodiment, the size of the flow mixing diverter is proportional to the size of the flow conditioning aperture. The size of the flow mixing diverter may be further proportional to the size of an intended conduit.

The present invention is further direct to an ultrasonic flow meter including a flow condition insert for insertion in a flow conduit transporting a flow stream through the ultrasonic flow meter. The flow conditioning insert includes an inlet side receiving the flow stream, an outlet side receiving the flow stream after the flow stream passes through the inlet side, and an internal structure positioned between the inlet side and the outlet side and positioning the flow conditioning device within the flow conduit. The internal structure includes a plurality of a flow conditioning apertures extending between the inlet side and the outlet side and a plurality of flow mixing diverters positioned within one or more flow conditioning apertures, each flow mixing diverter imparting a directional flow condition on fluid passing through a flow conditioning aperture that includes the flow mixing diverter.

Other features of the flow conditioning insert, besides those discussed above, will be apparent to those of ordinary skill in the art from the description of the preferred embodiments which follows. In the description, reference is made to the accompanying drawings, which form a part hereof, and which illustrate examples of the invention. Such examples are illustrative, but for the scope of the invention, reference is made to the claims which follow the description.

### BRIEF DESCRIPTION OF THE DRAWINGS

FIG. 1A is a perspective view of a flow conditioning insert from an inlet side, according to an exemplary embodiment;

FIG. 1B is a perspective view of the flow conditioning insert of FIG. 1A from an outlet side, according to an exemplary embodiment;

FIG. 2A is an inlet side view of the flow conditioning insert of FIG. 1A, according to an exemplary embodiment;

FIG. 2B is a side view of the flow conditioning insert of FIG. 1A, according to an exemplary embodiment;

FIG. 2C is an outlet side view of the flow conditioning insert of FIG. 1A, according to an exemplary embodiment;

FIG. 2D is a cross section view of the flow conditioning insert of FIG. 1A, according to an exemplary embodiment;

FIG. 3A is a perspective view of a flow conditioning insert from an inlet side, according to an alternative embodiment;

FIG. 3B is a perspective view of the flow conditioning insert of FIG. 3A from an outlet side, according to an alternative embodiment;

FIG. 4A is an inlet side view of the flow conditioning insert of FIG. 3A, according to an alternative embodiment;

FIG. 4B is a side view of the flow conditioning insert of FIG. 3A, according to an alternative embodiment;

FIG. 4C is an outlet side view of the flow conditioning insert of FIG. 3A, according to an alternative embodiment;

FIG. 4D is a cross section view of the flow conditioning insert of FIG. 3A, according to an alternative embodiment;

FIG. 5A is a perspective view of the flow conditioning insert of FIG. 3A within a flow meter, according to an exemplary embodiment; and

FIG. 5B is a cross section view of the flow conditioning insert of FIG. 3A within a flow meter, according to an exemplary embodiment.

### DETAILED DESCRIPTION OF THE INVENTION

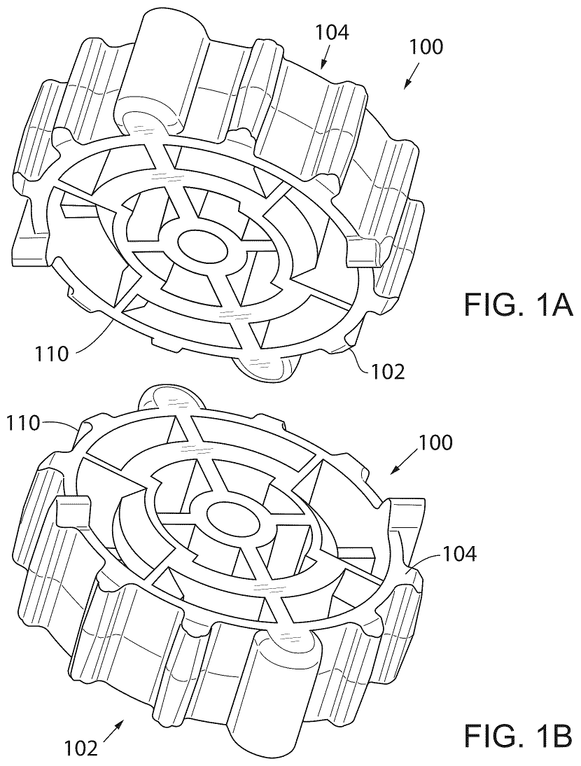

Referring first to FIGS. 1A and 1B, different perspective views of a flow conditioning insert 100 are shown, according to an exemplary embodiment. The flow conditioning insert 100 is configured to reduce asymmetry in a flow using multiple flow conditioning formations that reduce variation and non-uniform asymmetry in the flow profile to facilitate flow measurement. The flow conditioning formations, as further described below, reduce asymmetries in the flow profile to mix the pattern of flow velocity and consistently distribute the flow including the asymmetries uniformly across a cross-section of the flow profile. The flow conditioning insert 100 is shown in a perspective view from an inlet side in FIGS. 1A and 1n a perspective view from an outlet side in FIG. 1B, according to the same exemplary embodiment.

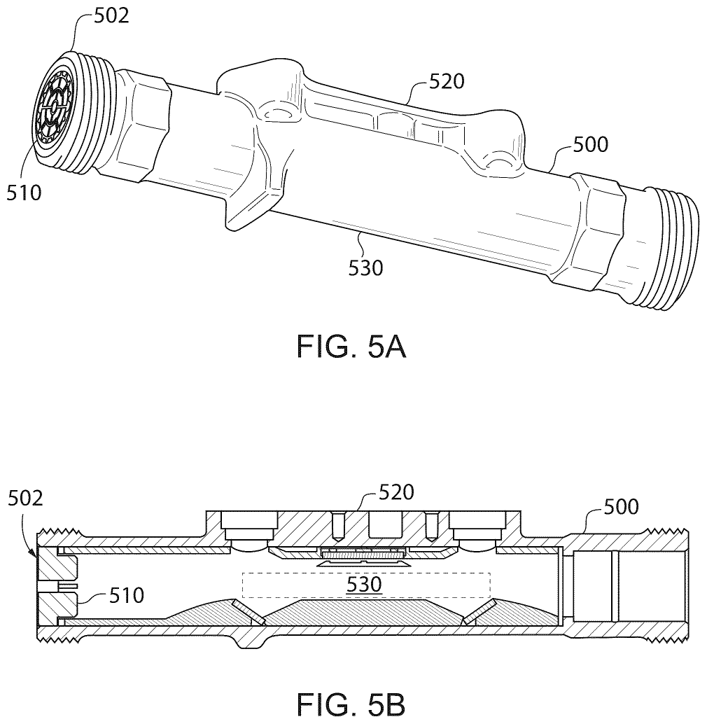

Flow conditioning insert 100 features an essentially cylindrical configuration having an inlet surface 102 and an outlet surface 104 with an internal structure 110 extending from the inlet surface 102 to the outlet surface 104. Inlet surface 102 and outlet surface 104 may be configured to be perpendicular to a conduit axis when the conditioning insert 100 is positioned within the conduit, as shown and described below with reference to FIGS. 5A-5B. Internal structure 110 is configured to extend from the inlet surface 102 to the outlet surface 104. The length of the internal structure 110 may be configured to extend essentially parallel to the conduit axis when the conditioning insert 100 is positioned within the conduit.

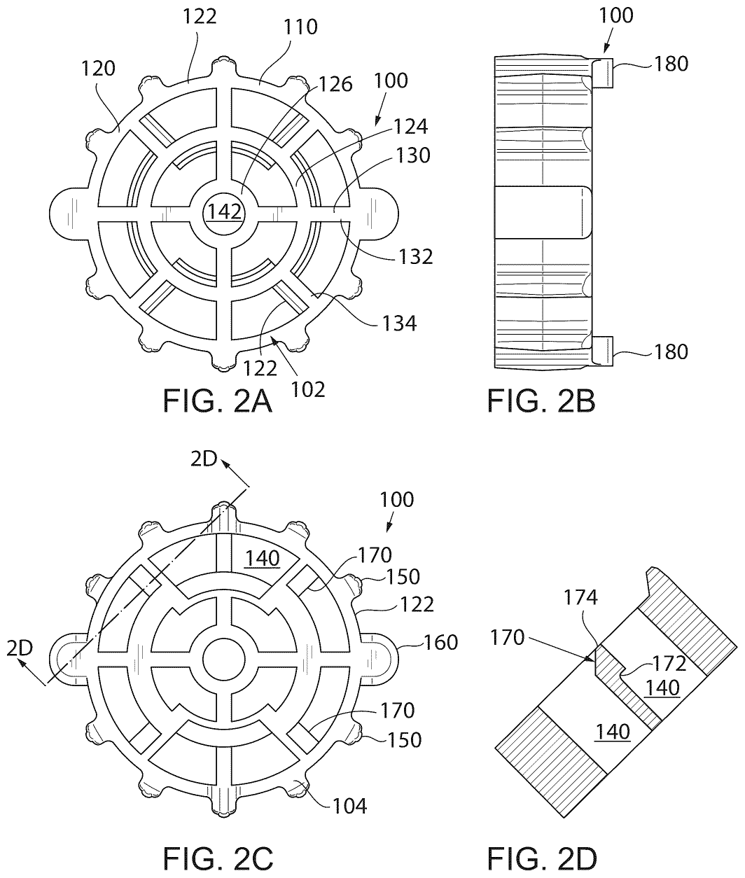

The diameter of the flow conditioning insert 100 and the length of the internal structure 110 may be modified based on the intended application of the flow conditioning insert 100. For example, the diameter of the flow conditioning insert 100 may be selected based on the diameter of a conduit in which the flow conditioning insert 100 is to be utilized. In the example shown in FIGS. 1A-2D, flow conditioning insert 100 is configured for use in a traditional DN15 (nominal diameter 15 mm) conduit, according to an exemplary embodiment. In an alternative embodiment (not shown), flow conditioning insert 100 may be implemented as being roughly rectangular such that the insert 100 may be used with a rectangular conduit or within a rectangular channel within any shaped conduit. The length of the internal structure 110 may be selected based on, for example, the degree of flow conditioning desired from the flow conditioning insert 100, anticipated fluid pressure within a conduit, anticipated asymmetry, anticipated fluid type, etc.

Referring now also to FIGS. 2A-2D, an internal structure 110 in a flow conditioning insert 100 is shown, according to an exemplary embodiment. Internal structure 110 includes one or more structural rings 120 that may extend to form cylinders along the length of the internal structure 110 essentially perpendicular to the surfaces 102 and 104. Internal structure 110 further includes a plurality of radial extensions 130 that extend between these structural rings 120 and also extend perpendicular to the surfaces 102 and 104.

In the embodiment shown in FIGS. 2A-2D, internal structure 110 is shown as including an outer structural ring 122, a middle structural ring 124 and a central structural ring 126. Central structural ring 126 may define a central flow channel 142 as shown in this embodiment. In alternative embodiments, internal structure 110 may include more or less structural rings 120 and/or a different structure that defines numerous flow apertures configured for flow conditioning. Although structural rings 120 are shown and described herein as being circular, one of ordinary skill in the art would understand that a variety of different shapes may be used depending on the intended application for the flow conditioning insert 100.

Radial extensions 130 are configured to extend between and give support to two or more structural rings. Full radial extensions 132 are configured to extend between and provide support to all of the structural rings 120 in an internal structure 110. Partial radial extensions 134 are configured to extend between less than all of the structural rings 120.

Structural rings 120 and radial extensions 130 form a plurality of internal flow conditioning apertures 140 that extend between inlet surface 102 and outlet surface 104. The size and shape of each of the flow conditioning apertures will be defined by the structural rings 120 and radial extensions 130. Internal flow conditioning apertures 140 are configured to allow fluid, being conducted through the conduit in which the flow conditioning insert 100 is positioned, to flow and be conditioned by flow conditioning insert 100.

Internal structure 110 further includes a plurality of conduit interface extensions 150 configured to extend radially outward from the outer structural ring 112. In the embodiment shown in FIGS. 2A-2D, interface extensions 150 are shown as protuberances although a variety of number of extensions 150, positionings of extensions 150, and shapes of extensions 150 may be used in different applications. Extensions 150 are configured to extend outward from outer structural ring 112 to a distance equal to an inner diameter of the conduit in which flow conditioning insert 100 is intended to be used. Extensions 150 may be configured to interface with one or more conduit feature to position and secure insert 100 within a conduit.

Internal structure 110 further includes one or more locking extensions 160 configured to extend radially outward from the outer structural ring 112. Locking extensions 160 are configured to extend outward from outer structural ring 112 to a distance greater than an inner diameter of the conduit in which flow conditioning insert 100 is intended to be used. Locking extensions 160 are configured to interface into one or more locking openings in a conduit (not shown) to secure the flow conditioning insert 100 in position within the conduit to provide the flow conditioning.

Structural rings 120, radial extensions 130, and conduit interface extensions 150 may be configured to extend the entire length, more than the entire length, or less than the entire length of the internal structure 110. For example, a central structural ring 116 may be configured to extend only along a portion of the length between inlet surface 102 and outlet surface 104, and the lengths of radial extensions 130 between the central structural ring 116 and a middle structural ring 114 maybe sized based on the length of the central structural ring 116 rather than the length of the entire internal structure 110.

Internal structure 110 further includes one or more flow mixing diverters 170. Flow mixing diverters 170 are configured to extend from a structural ring 120 or a radial extension 130 into a flow conditioning aperture 140. Flow mixing diverters may be configured to cooperatively provide a flow conditioning profile to fluid passing through insert 100.

For example, in the embodiment shown in FIGS. 1A-2D, flow mixing diverters 170 are positioned within four (4) quadrants to cooperatively impart a helical swirl in each of the four different quadrants. Although quadrants are shown and described herein, mixing diverters and their associated flow conditioning apertures may be divided into a variety of different subgroups. Each of the mixing diverters 170 are configured to divert fluid flowing through the quadrant in a consistent helical direction, essentially generating four (4) helical swirls in fluid exiting the insert 100. Advantageously, creating helical swirls extend the consistency and duration of the flow conditioning effects generated by insert 100.

Internal structure 110 may be configured to include a flow mixing diverter 170 in every aperture 140, as shown in FIG. 2A-2D, or in select apertures 140 depending on the desired flow conditioning effect to be achieved. The flow mixing diverters are configured to impart a directional flow condition away from the location of the flow mixing diverter within a flow conditioning aperture 140.

As shown in FIGS. 2A-2D, flow mixing diverters 170 may be formed at a terminal end of a structural ring 120 or a radial extension 130 proximate to the outer surface 104 as shown in the exemplary embodiment. In alternative embodiments, flow mixing diverters may be positioned along the length of the internal structure 110, dependent on the flow conditioning effect to be realized.

A particular shape of a flow mixing diverter 170 is shown in the exemplary embodiment of a flow conditioning insert 100. In this shape, a first end 172 of flow mixing diverter 170 may extend into a flow aperture 140 essentially perpendicular to the length of the internal structure 110 and into a flow passing through the flow aperture 140. From this perpendicular extension, the flow mixing diverter may extend essentially parallel to the length of the axis of the internal structure 110. An opposite end 174 of the flow mixing diverter 170 from the parallel extension, may extend towards the flow aperture 140 such that a first end of the flow mixing diverter 170 closer to the inlet surface 102 is larger than a second end of the flow mixing diverter 170 closer to the outlet surface 104. Accordingly, a flow mixing diverter 170 may decrease the size of the flow aperture 140 while increasing the size of one or more adjacent flow apertures 140. Advantageously, this configuration will increase the flow speed through the aperture having the flow mixing diverter will decreasing the flow speed in an adjacent area of an adjacent aperture, which will increase the effectiveness of the flow mixing diverter 170. Although a particular size and location of flow mixing diverters 170 is shown and described herein, a variety of shapes sizes and locations a flow mixing diverter 170 may be implemented in alternative shapes and sizes depending on the flow conditioning profile to be achieved.

Internal structure 110 further includes one or more locating V-ribs 180. Locating V-ribs 180 are configured to assist in positioning insert 100 with a conduit.

Although a particular embodiment of internal structure 110 is shown in FIGS. 2A-2D, one of ordinary skill in the art should appreciate that a variety of configurations may be implemented. For example, a size, such as the length and width of the internal structure 110, structural rings 120 and radial extensions 130 may be modified. The internal structure 110, structural rings 120 and radial extensions 130 be varied based on the particular application and desired flow conditioning properties. Yet further, the length, number, and location of the structural rings 120, the radial extensions 130, the flow apertures 140 and the conduit interface extensions 150 may also be modified based on the intended application of the flow conditioning insert 100.

Although a specific configuration and diameter of internal structure 110 is shown and described, one of ordinary skill in the art would easily understand that the configuration and diameters of apertures 110 may vary considerably dependent on the size of the pipe, the type of fluid, etc. and still achieve the advantages described herein.

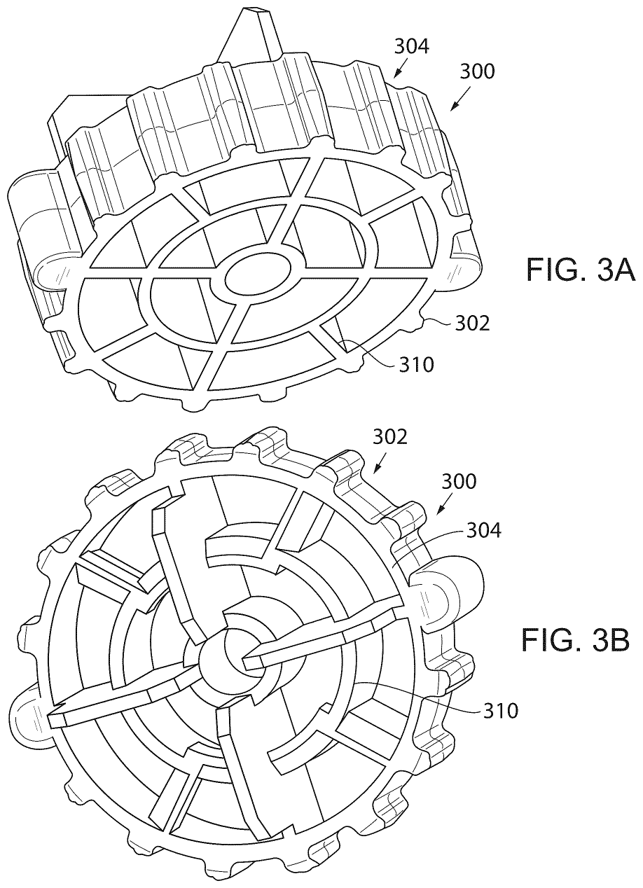

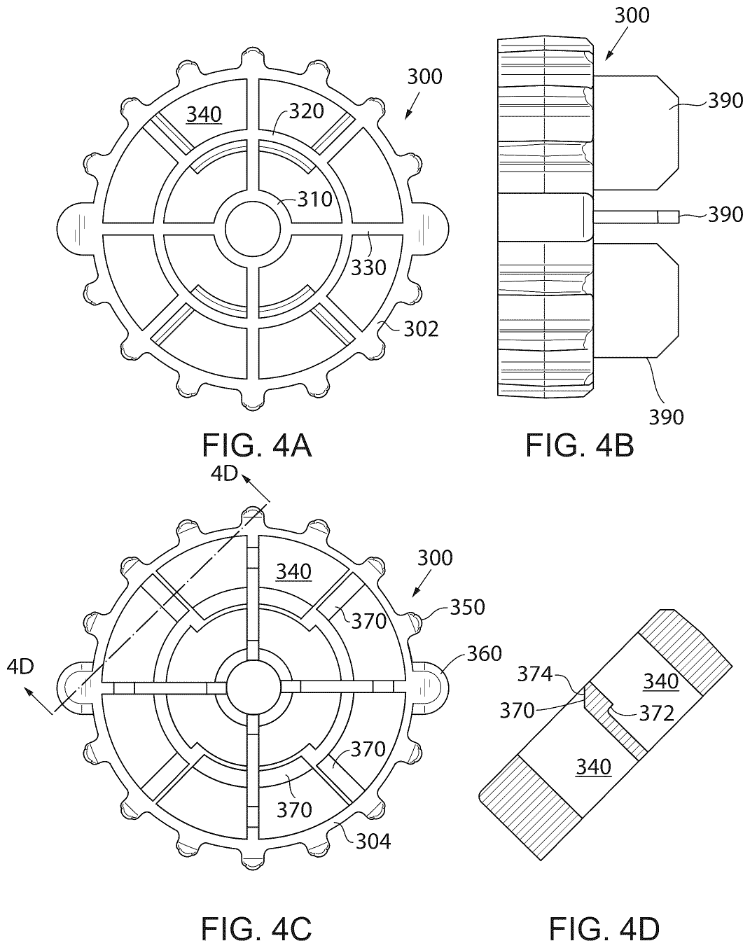

Referring next to FIGS. 3A and 3B, a perspective view of a flow conditioning insert 300 is shown, according to an exemplary embodiment. In the exemplary embodiment shown in FIGS. 3A-4D, flow conditioning insert 300 is configured for use in a traditional DN20 (nominal diameter 20 mm) conduit, according to an exemplary embodiment. Although a different configuration, one of ordinary skill in the art will appreciate that the flow insert 300 includes common features with flow insert 100 as described above. The following description will be limited to highlighting the differences between flow insert 100 and flow insert 300 to illustrate modification based on different sizing, desired flow profiles, etc. The flow conditioning insert 300 is shown in a perspective view from an inlet side in FIG. 3A and in a perspective view from an outlet side in FIG. 3B, according to the exemplary embodiment.

Flow conditioning insert 300 again features an essentially cylindrical configuration having an inlet surface 302 and an outlet surface 304 with an internal structure 310 extending from the inlet surface 302 to the outlet surface 304. Internal structure 310 may be configured to be parallel to the conduit axis when the conditioning insert 300 is positioned within the conduit. The diameter of the flow conditioning insert 300 and the length of the internal structure 310 has been modified based on the intended DN20 application.

Referring now also to FIGS. 4A-4D, an internal structure 310 is shown according to an exemplary embodiment. Internal structure 310 includes one or more structural rings 320 that may be essentially perpendicular to the surfaces 302 and 304. Internal structure 310 further includes a plurality of radial extensions 330 that extend between these structural rings 320 perpendicular to the surfaces 302 and 304. It is noteworthy that the width of components of the internal structure 310 across the face of surfaces 302 and 304 has been reduced. The reduction is made to reduce any pressure drop caused by flow insert 100 that has a greater impact in the larger diameter DN20 conduit.

Referring now also to FIGS. 4A-4D, flow insert 300 includes an internal structure 310, one or more structural rings 320, and a plurality of radial extensions 330 similar to those of flow insert 100.

Structural rings 320 and radial extensions 330 form a plurality of internal flow conditioning apertures 340 that extend between inlet surface 302 and outlet surface 304. The size and shape of each of the flow conditioning apertures will be defined by the structural rings 320 and radial extensions 330. Internal flow conditioning apertures 340 are configured to allow fluid being conducted through the conduit in which the flow conditioning insert 300 is positioned to flow and be conditioned by flow conditioning insert 300. In an exemplary embodiment, the size of the flow apertures 340 is configured proportionally to the size of the intended conduit application.

Internal structure 310 also further includes one or more flow mixing diverters 370. Flow mixing diverters 370 are configured to extend from a structural ring 320 or a radial extension 330 into a flow conditioning aperture 340. As seen, a different configuration of flow mixing diverters 370 is shown in the exemplary embodiment. In the embodiment shown, only two of the three flow apertures 340 in each quadrant are configured to include a flow mixing diverter 370.

In the embodiment shown in FIGS. 3A-4D, flow mixing diverters 170 are still positioned within four (4) quadrants to cooperatively impart a helical swirl in each of the four different quadrants. However, the omission of one flow mixing diverter will affect the degree and shape of the helical swirl imparted to fluid flowing through insert 300. Each of the two mixing diverters 170 are still configured to divert fluid flowing through the quadrant in a consistent helical direction, generating four (4) helical swirls in fluid exiting the insert 100. Advantageously, creating helical swirls extend the consistency and duration of the flow conditioning effects generated by insert 100.

Flow insert 300 is configured to further include a plurality of flow outlet vanes 390 configured to isolate the helical swirls created within insert 300 beyond the length of the internal structure 310. The size and shape of the flow outlet vanes may be configured based on the intended application for insert 300.

A particular shape of a flow mixing diverter 370 is shown in the exemplary embodiment of a flow conditioning insert. In this shape, a first end 372 of flow mixing diverter 370 may extend into a flow aperture 340 essentially perpendicular to the length of the internal structure 310 and into a flow passing through the flow aperture 340. From this perpendicular extension, the flow mixing diverter may extend essentially parallel to the length of the axis of the internal structure 310. An opposite side of the flow mixing diverter 370 from the parallel extension, may extend towards the flow aperture 340 such that a first end of the flow mixing diverter 370 closer to the inlet surface 302 is larger than a second end of the flow mixing diverter 370 closer to the outlet surface 304. Accordingly, a flow mixing diverter 370 may decrease the size of the flow aperture 340 while increasing the size of one or more adjacent flow apertures 340. Although a particular size and location of flow mixing diverters 370 is shown and described herein, a variety of shapes sizes and locations a flow mixing diverter is 370 may be implemented in alternative embodiments depending on the flow conditioning profile to be achieved.

As shown in FIGS. 3A-4D, the amount that each flow mixing diverter 370 extends into an aperture 340 may be customized. For example, the amount of the extension may be modified based on the desire flow conditioning profile, the diameter of the conduit that the flow conditioning insert will be positioned in to avoid pressure drop, etc.

Referring now to FIGS. 5A and 5B, an ultrasonic flow measurement conduit 500 including an in-situ flow conditioning insert 510 similar to flow conditioning insert 300 is shown in perspective and cross section views respectively, according to an exemplary embodiment. Ultrasonic flow measurement conduit 500 includes an ultrasonic meter attachment point 520 configured to receive an ultrasonic meter configured to monitor flow within a measurement area 530 in the conduit 500. The in-situ flow conditioning insert 510 is positioned in an inlet 502 of the flow measurement conduit 500.

According to an exemplary embodiment, flow conditioning insert 510 is positioned [X] mm upstream from the flow measurement area 530 to allow the flow conditioned by flow conditioning insert 510 to stabilize prior to measurement by the ultrasonic meter. The positioning length may be proportional to the size of the conduit.

Flow conditioners as described herein in the above embodiments reduce the straight pipe length and provide that is required to achieve accurate measurement. Further, the flow conditioners described herein provide this advantage by reducing the amount of restriction to the flow to avoid significantly reducing flow velocity and introducing a pressure drop. This reduction saves materials, space and cost.

This has been a description of exemplary embodiments, but it will be apparent to those of ordinary skill in the art that variations may be made in the details of these specific embodiments without departing from the scope and spirit of the present invention, and that such variations are intended to be encompassed by this description.

What is claimed is:

1. A flow conditioning insert for insertion in a flow conduit transporting a flow stream, comprising:
an inlet side receiving the flow stream;
an outlet side receiving the flow stream after the flow stream passes through the inlet side; and
an internal structure positioned between the inlet side and the outlet side and positioning the flow conditioning device within the flow conduit, the internal structure including
a plurality of a flow conditioning apertures extending between the inlet side and the outlet side and
a plurality of flow mixing diverters positioned within one or more flow conditioning apertures, each flow mixing diverter imparting a directional flow condition on fluid passing through a flow conditioning aperture that includes the flow mixing diverter.

2. The flow conditioning insert of claim 1, wherein the flow conditioning apertures are divided into subgroups and the flow mixing diverters within each subgroup are configured to cooperatively impart the directional flow condition.

3. The flow conditioning insert of claim 2, wherein the directional flow condition is a helical swirl.

4. The flow conditioning insert of claim 3, wherein the subgroups form quadrants of flow conditioning apertures.

5. The flow conditioning insert of claim 2, further including one or more flow outlet vanes isolating a flow output from each subgroup beyond the length of the internal structure of the flow insert.

6. The flow conditioning insert of claim 1, wherein the size of the flow mixing diverter is proportional to the size of the flow conditioning aperture.

7. The flow conditioning insert of claim 6, wherein the size of the flow mixing diverter is further proportional to the size of an intended conduit.

8. An ultrasonic flow meter configured to measure flow through a conduit, comprising
a flow conditioning insert for insertion in the flow conduit transporting a flow stream to be measured by the ultrasonic meter, the insert including
an inlet side receiving the flow stream;
an outlet side receiving the flow stream after the flow stream passes through the inlet side; and
an internal structure positioned between the inlet side and the outlet side and positioning the flow conditioning device within the flow conduit, the internal structure including
a plurality of a flow conditioning apertures extending between the inlet side and the outlet side and
a plurality of flow mixing diverters positioned within one or more flow conditioning apertures, each flow mixing diverter imparting a directional flow condition on fluid passing through a flow conditioning aperture that includes the flow mixing diverter.

9. The ultrasonic flow meter of claim 8, wherein the flow conditioning apertures are divided into subgroups and the flow mixing diverters within each subgroup are configured to cooperatively impart the directional flow condition.

10. The ultrasonic flow meter of claim 9, wherein the directional flow condition is a helical swirl.

11. The ultrasonic flow meter of claim 10, wherein the subgroups form quadrants of flow conditioning apertures.

12. The ultrasonic flow meter of claim 9, further including one or more flow outlet vanes isolating a flow output from each subgroup beyond the length of the internal structure of the flow insert.

13. The ultrasonic flow meter of claim 8, wherein the size of the flow mixing diverter is proportional to the size of the flow conditioning aperture.

14. The ultrasonic flow meter of claim 13, wherein the size of the flow mixing diverter is further proportional to the size of the conduit.
